(19) United States
(12) Patent Application Publication
(10) Pub. No.: US 2023/0393663 A1
(43) Pub. Date: Dec. 7, 2023

(54) Method for Search and Display of Geographic Points of Interest on Computing Devices Accounting for Predetermined Rankings Assigned to Geographic Points of Interest

(71) Applicant: Yellcast, Inc., San Carlos, CA (US)

(72) Inventors: Peter Ellenby, Portland, OR (US); Thomas William Ellenby, Langhorne, PA (US); William Foster, Santa Fe, NM (US); Ganesan Venkatakrishnan, San Carlos, CA (US); Peter Negulescu, San Francisco, CA (US); John Vernagus, Las Vegas, NV (US)

(21) Appl. No.: 17/834,841

(22) Filed: Jun. 7, 2022

(51) Int. Cl. G06F 3/01; G01C 21/36; G01C 21/34; G06F 16/2457; G06F 16/248

(52) U.S. Cl. CPC G06F 3/017; G01C 21/3664; G01C 21/3476; G01C 21/3682; G06F 16/24575; G06F 16/248

(57) ABSTRACT

The system obtains a state of a mobile device at a first interaction time, obtain a second state of a mobile device at a second interaction time, determines a gesture based on the state and the second state of the mobile device, determines a first set of search results, via a query of a point of interest database, based at least in part on the determined the determined gesture, determines a second set of search results based a first filtering criteria; and display the first and second set of search results on the mobile device.

### FIELD

The present disclosure generally relates to localized searching using a mobile device and more particularly to providing search results according to a plurality of levels of interest.

### BACKGROUND

People often rely on a mobile computing device to provide them, in real-time, with information about their local geographic environment. For example, a person might use a mobile computing device that can communicate with a remote service when navigating an unfamiliar city, town, or another geographic region might even use the mobile computing device in familiar cities, towns, or other geographic regions. The mobile computing device can provide the user with information from a remote service, such as a “points of interest” search engine. With a communications capability, the mobile computing device can send and receive communications between the mobile computing device and the remote service, such as over an Internet connection and/or a cellular mobile connection. As part of the communication, the mobile computing device might determine its geographic location and convey that to the remote service whereby the remote service takes into account the indicated geographic location.

The indicated geographic location can be determined in a number of ways and might be a proximate determination. The geographic location might be represented as a set of coordinates in a coordinate system. The remote service, in response to a search query from the mobile computing device, might return search results that might include information about landmarks, business locations, homes, points of interest, and the like they generally can be referred to as points of interest wherein points of interest have associated therewith their respective locations that can be represented by coordinates in the coordinate system.

Some search results returned by the remote service might include too many points of interest to be useful to a user, might include not enough points of interest to be informative to the user, or might be such that a point of interest actually of interest to the user is lost among a large number of irrelevant search results.

### SUMMARY

In an embodiment, there is infrastructure that mobile devices can connect to that each have storage for data and program code, such as a smartphone app. Functionality is provided for searching points of interest (“POI”), perhaps with a user interface for interacting with the user via smartphone displays and inputs, with sensors for position and orientation, to return search results based on stored POI data, and a network for them to communicate over and perhaps one or more servers that the smartphones communicating with. In general, a POI can be represented by a data structure storable in computer memory wherein the data structure indicates a particular point of interest, perhaps a category applicable to that point of interest, a geographic location for that point of interest, other details about the point of interest, possibly also keywords, tags, search terms, and the like associated therewith. A geographic location can be a specific point, an area, a volume, or a collection thereof suitable for indicating one or more locations, which can be locations relative to a user and/or a user's mobile computing device.

Users might undertake geographic searches for points of interest (POIs) from and their current real-world location, surrounding their current real-world location, or remotely as might be done where a user is not at a location but anticipates being at that location and/or is interested in that location. Searches can be initiated by users using their mobile computing devices. Examples of user devices include smart phones, tablets, desktop computers, laptop computers, and other devices capable of computing and communicating. When these searches are performed, for all POIs or for a specific category such as tourist attractions or restaurants etc., the results are generally displayed in order from their distance from the user's location or the area they have chosen to search for remotely. It is often the case that these users are looking for information about a specific POI that they can see, or they want information about the most relevant POIs in the area that they are searching. The world is often a cluttered place and when these searches are made the user is often inundated with irrelevant results of POIs that they have no interest in. These “chatter” or “noise” POIs may be closer to the user or to the area of search but are not what the user has interest in.

To provide a more useful set of results, the search results might be assigned to one or more of a plurality of tiers. In a specific embodiment, two tiers are used and are referred to in examples herein as a first tier with which important, or “Major”, POIs are associated while other POIs are associated with a second tier for less important, or “General” POIs. This can allow the user to get more relevant results from the searches they initiate.

A method of identifying a point of interest might include (1) determining a state of a mobile device, (2) determining a position of a mobile device or receiving a remote location, (3) determining a gesture based on the state of the mobile device, (4) obtaining a first set of search results, via a point of interest database, based at least in part on the second position value, the second orientation value, and the determined gesture, (5) determining a second set of search results based on a first filtering criteria, and (6) displaying the first and second set of search results on the mobile device.

The start of the gesture and the end of the gesture encompass a swinging or pointing motion using the mobile device. The user may gesture towards a POI by moving the end of the mobile device like a wand from a first position pointing towards the sky to a second position pointing at an object of interest. Examples of objects of interest may include buildings, open spaces, sculptures, or any landmark the user is interested in.

Embodiments described herein do not require an extended interaction with the mobile device to input a query about a POI, which in turn reduces the processing and memory required to query a POI. The embodiments also allow the information presented to be more focused based on an approximation of the geometric coordinates of interested, which reduces the amount of information to be retrieved from a remote server which in turn reduces the processing and memory required. Particularly, on mobile devices processing power and memory are at a premium, and reducing the processing and memory required increases the time available before the mobile device needs to be recharged.

This Summary is provided to introduce a selection of concepts in a simplified form that are further described below in the Detailed Description. This Summary is not intended to identify key features or essential features of the claimed subject matter, nor is it intended to limit the scope of the claimed subject matter. A more extensive presentation of features, details, utilities, and advantages of methods and apparatus, as defined in the claims, is provided in the following written description of various embodiments of the disclosure and illustrated in the accompanying drawings.

### BRIEF DESCRIPTION OF THE DRAWINGS

Various embodiments in accordance with the present disclosure will be described with reference to the drawings, in which:

FIG. 1 is an orthogonal drawing illustrating a mobile device performing a geogesture.

FIG. 2 is a flowchart illustrating a possible mode of operation of the invention utilizing a geogesture

FIG. 3 is a flowchart illustrating a possible mode of operation of the system for searching and displaying a geographic point of interest based on a first database of POI and a second database of POI.

FIG. 4 is a flowchart illustrating a possible mode of operation of embodiments utilizing a device determined position.

FIG. 5 is a flowchart illustrating a possible mode of operation of embodiments utilizing a search based on a location of the device and a first database and a second database of POI.

FIG. 6 is a flowchart illustrating a possible mode of operation of embodiments utilizing a search based upon a user selected position.

FIG. 7 is a flowchart illustrating a possible mode of operation of the system for searching and displaying a geographic point of interest based on a user defined location and a first database and a second database of POI.

FIG. 8 is a block diagram illustrating an example computer system upon which the systems illustrated in FIG. 1 may be implemented, according to various embodiments.

FIG. 9 illustrates an example computer system memory structure as might be used in performing methods described herein, according to various embodiments.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

Using smart mobile devices, and other devices, users can take local geographically based actions and engage in interactions that are initiated by and based upon a physical gesture of a mobile device, generally a mobile phone or a tablet. A gesture might be deemed to have been made upon detection of particular movements or actions as might be determined by the mobile device's accelerometers, gyroscopes or other internal sensors used to determine a device's spatial state and/or motion, combined with that device's real world position as sensed by the mobile device's positioning sensors such as GPS, AGPS or other position sensing technology and the device's compass bearing (pointing direction) as determined by the mobile device's compass or other means of determining pointing direction. For example, by monitoring the compass and accelerometers of the mobile device, or other sensors that record the spatial situation of mobile devices such as smart phones and tablets, the mobile device can initiate a local geographically based action and/or interaction in a specific direction.

A geolocated point of interest (POI) might be represented in a data structure by a single point, a latitude and longitude or other geographic coordinate system, POIs and Polygon and Polyhedron, or other 3D shapes such as spheres or cones, POIs. The system may receive input from a mobile device equipped with a positioning means, GPS, AGPS etc., and a means of determining the device's orientation such as a digital compass, gyroscopes etc., to sense the inputs from a user of the mobile device. The system may combine two or more pointing or casting actions. The system may determine two unique vectors based on the position of the phone and the orientation of the mobile device. The intersection of these vectors, each from a unique position (point A and point B), or shapes associated with these vectors results in a unique gesture. The system may determine the location of the POI based on the second position and the second orientation and based on a determined gesture. In an example, the point B of the gesture where the mobile device ends up corresponds to an approximate location of a single POI or one of the nodes for a polygon or polyhedron POI. In an example, the axis about which the mobile device rotates to the left or right after a casting gesture may correspond to an approximate location of a single POI or one of the nodes or polyhedron POI.

Rather than a search being performed, for all POIs or for a specific category such as tourist attractions or restaurants etc., and results displayed in order from their distance from the user's location or the area they have chosen to search for remotely, a more refined search result presentation could be provided. Such a presentation can address looking for information about a specific POI that is in front of a mobile device that is visible to the user of the mobile phone or the ability to retrieve information about the most relevant POIs in the area that they are searching without additional steps of reading or navigating manually through the search results. The world is often a cluttered place and when these searches are made the user is often inundated with irrelevant results of POIs that they have no interest in. These “chatter” or “noise” POIs may be closer to the user or to the area of search but are not what the user has interest in. The embodiments described herein remedy this problem by categorizing geographically located POIs, using a variety of methods, into important, Major, POIs and less important, General, POIs therefore allowing the user to get more relevant results from the searches they initiate.

The system can search a database of to determine a Major POI in the direction of the detected gesture such as cast based on the attributes associated with POI. Examples of attributes associated with the POI include but are not limited to the physical size of the POI, the social media parameters, the age of the POI, and other aspects associated with the POI. For example, a POI may be classified as major based on the size of the POI including but not limited to; height, surface level footprint, silhouette (3D outline) as viewed from current location. In an example, the system can map and store information relating to the sectors in a geographic location based on different “size” ratings associated with POIs. For example, the system can map the London Eye Ferris wheel, which is narrow when viewed from the side and therefore not that prominent as a general POI when the mobile device is located at the side of the London Eye Ferris wheel.

In an example, the system can determine whether a POI is Major or General POI based on the social media metadata associated with the POI. For example, the social media metadata associated with a POI can include a count of social media “Likes,” a count of social media “Likes” by a friend of the user, a follower of the user, a person the user follows on— a social media network, a count of social media geographic check ins at a POI, a count of a social media geographic check-ins at a POI by a friend of the user, a follower of the user and a person the user follows on social media network, a count of social media posts, hashtags or mentions relating to a POI, a count of social media posts, hashtags or mentions relating to a POI by a friend of the user, a follower of the user and a person the user follows on social media network, a count of social media followers of a POI, the number of social media follows of a POI by a friend of the user, a follower of a user and/or people the user follows on social media network, a count of photographs of the POI online or on a social media network, a count of photographs of a POI posted by a friend of the user, a follower of the user and a person the user follows on a social media network. The attributes of the POI that the system may use to determine the POI of interest includes but is not limited to whether a celebrity, or particular user selected celebrity, geographically checked in to or used a POI in a TV show, podcast, photo shoot etc., the actual age of a POI, the historical significance of a POI, whether the POI is the highest peer rated POI in a category, the actual population at or near a POI at the time of the search, the actual population at or near a POI at the time of search as posted by a friend of the user, a follower of the user and a person a user follows on social media network, the historic population at or near a POI over time, the historical population at or near a POI over time of a friend of the user, a follower of a user and a people the user follows on social media network, a curated POI database/list created by an individual or group (Historical Societies, pub crawls, scavenger hunts, etc.) such as “These are my top 100 London POI's,” a personal bookmarked POI of the user, a list of POIs compiled by trusted sources, a list compiled by a friend of the user, a follower of the user, and/or a person the user follows on a social media network, a number of accesses or user interactions with a POI, searches of, tickets bought etc., a number of accesses or a count of the number of user interactions with a POI, a searches of, tickets bought etc. by a friend of the user, a follower of the user, or an entity the user follows on a social media network, based on a monetary contribution by a party to display the POI as a major POI, and the time of the day or a season that impacts an attribute of the POI, and the like.

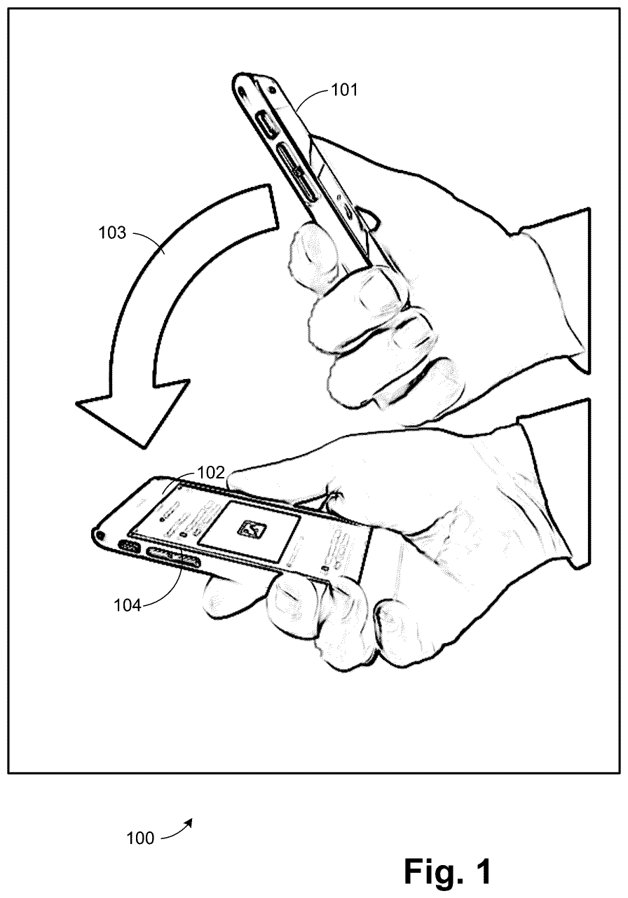

FIG. 1 is an orthogonal drawing 100 illustrating a mobile device. A mobile device at position 101 is pointed towards the sky and is at a first position and a first orientation or first state of the mobile device. The mobile device may then be moved by the user of the system towards the POI at position B 102, i.e., a second position and a second orientation, or a second state of the mobile device. The system identifies the gesture 302 which forms an arc from the first position 301 to the second position 302 as a gesture based on the first ray defined by the first position and first orientation and the second ray defined by the second position and second orientation. The mobile device is shown in two positions, at the start of a cast 301 and the end of a cast 302. The system may detect the motion between the two positions is shown as an arrow 303, such as a motion is in the vertical plane. In some embodiments, the system may detect a motion in the horizontal plane to trigger a cast. This system may detect the motion as the rate of change through the angle traversed, the actual angular change, or a combination of the two. The system may display the results of the search for the cast on the screen 304 of an electronic device or be utilized by applications or other systems operating an electronic device. The system may determine that the motion does not meet a threshold (e.g., rate of change of angular motion) in the horizontal and/or vertical planes and the system may determine the motion is not a cast and thus ignore the motion. In an example, the threshold may be pre-defined or pre-set. In one or more implementations, the threshold is dynamically determined based on typical movement of the device.

Based on the geogesture the system may simultaneously search a database of POIs to obtain a “General” search result, the first result set, and a “Major” search result, the second result set simultaneously. It should also be noted that the initial general search may also have an associated minimum threshold for results that, if not met, would also increase the search area for that search. It should also be noted that the system may be based on the iterations of increasing the search area determine whether the minimum threshold for results is not met and the system may limit further searches. For example, when the system determines after two iterations the results set does not meet the minimum required the system may not perform iterations or if a maximum range threshold has been reached for the extent of the search area, then the system does not perform further iterations. It should also be noted that a simpler version of such a search method as described above need not include a minimum result threshold and instead would return the results of the initial search and filtering as is.

In an example, the system determines the position of the POI based on the second position 102 of the mobile device. The system determines a first set of search results based on the determined position of the POI, and the determined gesture based on a query of a POI database. The system then determines a second set of search results based on a first filtering criterion. The first filtering criteria can be based on classification of the POI using various attributes of the POI. For example, the filtering criteria can be based on the size of a POI such as the largest POI in an area, or a POI with the largest number of associated social media metadata, the largest count of social media metadata, a personal attribute associated with a user, a combination of one or more such attributes, etc.,

In an example, the mobile device may be located in Battery Park at the southern tip of the island of Manhattan or the user may select the location as Battery Park at the southern tip of the island of Manhattan. The system will perform a search with a geographic search program based on the gesture received by the system. The system may locate the POI based on the gesture, the location of the device and based on a first filtering criterion. The system will retrieve the POI description and information based on the located POI and display the information on the mobile device. In an example, the system may perform a 360-degree search for tourist attractions POIs near the mobile device. Without the gesture-based search described herein, at Battery Park location a geographic search using mapping software might not present the most prominent and noticeable POI, namely the Statue of Liberty, because the Statue of Liberty is on a different island than Manhattan and the search based only on location will present the most prominent and noticeable tourist POI far down the list of tourist POIs. Moreover, a person might not be able to see more relevant POIs, such as a piece of the Berlin Wall and the Wall Street Bull, which might be displayed before the far more important and relevant tourist POI in plain sight at the location, i.e., the Statue of Liberty. This might be because the search is based on proximity to the mobile device instead of the POI in the light of sight of the mobile device.

The system might determine both a major and general POIs. The system may use a curated list of POIs that includes a notation indicating whether the POI is a major POI or a general POI compiled to provide information about the POI. In an example, the system may receive information about a POI as a major or general POI from a group such a tourism provider to generate a database. In an example, the database of POI for tourism may include the Statue of Liberty listed as the sixth major POI with respect to tourist spots in New York and may omit the Berlin Wall or the Wall Street Bull. In an example, the system based on the curated POI database, the gesture and/or the location of the device display the list of tourist POIs with the major POIs, including the Statue of Liberty, at the top or near the top of the search results list. The system thus provides a more relevant search result about the tourist POIs near Battery Park.

It should be noted the system could display any number of lists derived from the search results. In an example, the system may display the major POIs alone, the major and general POIs sorted together in some manner with an annotation about each POIs designation as major or general, the general POIs alone, the major POIs at the top of the list followed by the general POIs, etc. In this manner, the system may present new and novel information about their surroundings that may be of interest to a user that the user may not know exists nearby or that it exists at all. In an example, the system may display the section of the Berlin Wall that is located in Manhattan for instance, may be of interest to a user interested in history based on the personal metadata associated with the user. In an example, the system may determine the POI based on the user interests and display that result with the top POI.

The system may use different methods to determine which POI lists to display based on information about a user of the system. In an example, the system can determine and display the POI in order of the highest ranked major POI to the lowest ranked major POI, in order of distance from the search location of a user or determine their rank based on one criteria of the multiple criteria, or determine their rank based on an average of all the criteria.

The system may include a method of selecting or moving between these lists of major, combination of major and general, and general POIs. In an example, the system can determine a gesture that detects a toggle or “turn” of the screen to switch between two different lists such as the major POI and general POI. In an example, the system may utilize the accelerometers and gyroscopes in the mobile devices to determine the toggle or “turn” gesture that displays different lists on the screen. In an example, the system may detect the rotation of the mobile device either left or right to change the POI list displayed on the screen for viewing and detect an opposite rotational gesture to return to the previous POI list. For example, assume the mobile device is located at Battery Park during the initial search and the system displays a POI list of the major POIs in the area, with the Statue of Liberty at the top of list. The system may receive a rotational gesture to the right to view the list of general POIs in the area. The system may determine the rotation gesture based on the gyroscopes and the accelerometers, and the device display may switch to the list of general POIs in the area including the section of the Berlin Wall, and the other general POIs. In an example, the system may determine a gesture rotating to the left twice as a request to combine the major and general POI in the area. In an example, the system may determine several variations of the rotational gesturing, and/or other gestures could be used to switch between list of geographically searched POIs.

In an example, the system may determine the location is Shibuya ward located in the city of Tokyo, Japan. The system may determine that the mobile device is located at the main crossing in the ward, a huge and bustling intersection with hundreds, perhaps thousands of POIs located on its streets and those around it. The system may receive a gesture from the mobile device to perform a geographic search for all POIs nearby, stores, restaurants, tourist attractions, transit etc. In an example, without a form of prioritizing the POI, the system will inundate the screen with results that most likely would not be of interest. For example, the system will not prioritize the POI based on the preference of the user such as discovering most popular POIs to see, POI on what to eat and/or what to do, in and around the Shibuya Crossing. In an example, the system according to an embodiment, may search for all POIs nearby while they are located at the Shibuya Crossing, the determine the major and the general POIs. In an example, they system may include social media parameters such as social media check ins and likes, photo posts along with social media mentions or hashtags (a hashtag—#is a common way of confirming reference to a place, subject, person etc. on a social media post) to determine if a POI is major or general. In an example, the system then returns the top three major POIs on their search result list that are more relevant such as the statue of Hachiko the dog, the massive Starbucks overlooking the crossing and the Shibuya 109 shopping center. In an example, the system may show the locations that are not based the top three major POI's that the user can visit and enjoy near the Shibuya Crossing to allow the user to explore alternative POI's.

It should be noted that the system may use the methods described for the previous example, using social media statistics and photography posts to define major or general POI designation, to determine a result that includes a small sized POIs in the area as the top and most popular POI. For example, the system may determine that the statue of Hachiko the dog is perhaps one of the most beloved monuments (the monument was erected to honor a loyal dog who waited for his owner every day at Shibuya Station, even for months after the owner had died and no longer returned from work) in Tokyo and is one of Shibuya's most popular meeting places. The system may be based on the POI determine that even though the monument is not physically large it is the most important POI. For example, the system may be based on the social media statistics determine the statue of Hachiko the dog is the most popular POI at the Shibuya Crossing, even though the Hachiko statute which sits atop of a modest stone base that roughly measures only 3×6 feet and is roughly 6 feet tall is dwarfed in size by surrounding POIs such as the Shibuya train station, hotels, and shops. In this instance, the system may determine the POI of interest is the modest sized POI instead of the larger POI in the crossing.

In an example, they system may determine that the physical size of a POI is relevant to its classification as a major or general POI. For example, the system may determine that the largest things that are visible in their surroundings may be of interest to a user. In an example, the system may determine that the device is located in the city of London. The system may receive a gesture that geographically searches in 360 degrees pattern for tourist POIs. The system may determine the mobile device is located in the Victoria Tower Gardens just to the south of the Palace of Westminster (the palace includes Parliament and Big Ben) on the bank of the river Thames. The system without the use of the gesture-based search will return tens and tens of tourist POIs located in and near the Victoria Tower Gardens, many of which are quite small in size and may not be of interest to the tourist. For example, the system may determine numerous POS such as statues, small monuments and even small patches of flower beds located in and around the gardens. The system without the additional gesture based second filtering criteria display the chatter or noise POIs, the general POIs, before the large POIs that is visible to the user and the user is interested in. In an example, the system may determine the POI to be displayed based on a second filtering criteria such as the physical size of a POI to determine its designation as a major or general POI. The system may display the major POIs as determined by size located near the mobile device such as the Palace of Westminster, the Cromwell House, Westminster Abbey, and the river Thames. The system may provide search results that are much more easily accessible and are more relevant based on the gestured based second filtering criteria.

In an example, the system may display the major POIs from their previous search. The system may determine that the location is now north of the original search location in Whitehall Gardens also located on the bank of the river Thames just a small distance from the Palace of Westminster. The system 100 may determine that the garden is surrounded by planting beds with large bushes and trees that block the view of anything outside of the gardens except for tall objects. The system may receive a gesture to determine, what POI the large Ferris wheel towering over the river Thames on the opposite bank. The system may receive a directional search application that determines the POI and displays the results of the POI. For example, the system can display the name of the POI, the transit options to the POI, the cost of the transit options, the time to reach the POI, the average wait time at the POI and the like. For example, the system determines based on a mobile device's positioning technology (GPS, AGPS, cell tower triangulation, Wi-Fi etc.) and the mobile device's sensors (digital compass, accelerometers & gyroscopes etc.) to perform geographic searches in a specific direction, by pointing at things, POIs, in the real world and be receive information about the objects that the user points at. In an example, the system may reactive a gesture which indicates the point of interest is a Ferris wheel and may perform a search. In an example, the system may return results that are not relevant to the user. For example, the system may return results about the various Thames boat cruise companies, commercial boating enterprises, some minor monuments, and even a pub that is on a boat in the Thames. The system may without the gesture based localized search rank the Ferris wheel, the London Eye far down the list. In an example, the system may display the chatter and noise POIs, the general POIs, that are not visible beyond the overgrown bushes and trees first. In an example, the system may receive a gesture to perform a search based on a POI physical size such as a POI's height, to determine major and general POIs. In response to the gesture, the system may display the London Eye, being by far the tallest POI in that direction first. The system may display information about the London Eye, the POI that had caught the attention of the user to begin with.

In an example, the system may determine a major POI based on a compensation scheme that rewards the developer of the POI database. For example, the system may determine a food cart pod in Portland, Oregon that takes up an entire city block may be a major POI and display the major POI. However, the pod houses 32 different food carts of various cuisines. The system may determine that one cart, Bob's BBQ, has paid the organization that runs the system or app used to perform the searches is displayed as a major POI. In an example, the system may show the pod and the Bob's BBQ near the top of the list and deprioritize the other carts are lower on the list because the other carts are designated as general POIs.

In an example, the system may determine the designation of a POI as major or general based upon user interaction or access of the POIs on a list after performing a geographic search. For example, the system may determine based on prior interactions and search history associated with a majority of users of the system are interested in a particular POI, which may result in the POI being designated as a major POI, and another POI may designate it as a general POI based on the diminished of interaction with another POI. In an example, the system may track the number of times a POI had been interacted with and designate the POI as major or general based on the number of interactions.

In an example, the system may determine a POI is to be designated as a major or general POI based on the time of year or perhaps even the time of day. For example, the system may designate the Rockefeller Center in New York City as a major POI during the winter when the ice-skating rink is installed, and the Christmas tree is up, and the center becomes a huge tourist attraction. In an example, the system may designate a POI as a major POI during the hours of business. For example, the system may display a business as a major POI during the opening hours and may in turn display the POI as a general POI when the POI is closed. In an example, the system may determine whether a POI is major or general POI based on other seasonal and timely factor.

In an example, the system may designate a POI as major or general POI based on the profile of the user in the POI. The system may determine whether a POI is a major POI, or a general POI based on used of the POI by a celebrity as a location of a television show (a celebrity chef highlighting a restaurant for their TV show), the number of visits by a celebrity to the POI and the like. In an example, the system may use a list of celebrities customized to the user of the search such as an exclusion list of celebrities, an inclusion list of celebrities or a combination of both. For example, the system may determine a POI as a general POI based on a particular celebrity chef on the exclusion list of a user.

In an example, the system may determine whether a POI is a major POI, or a general POI based on the demographics of the user. For example, the system may determine that a POIs caters to a certain age, such as nightclubs or bars. Where a POI of interest at a particular location has age restriction, or other restriction on accessibility, and that restriction is known during the search process, the designation assigned to such POI might be designated as a general location given that the user would not be allowed entrance due to restrictions. In an example, the system may determine based on age that POIs such as playgrounds, ice cream parlors or coffee shops designated as major POIs. Other demographic data can be used in a similar fashion and may also be used in conjunction with the other methods of determining if a POI is major or general.

In an example, the system may generate a major POI database based on inputs from a user, a social media share or other such input. For example, the system may receive a user created list of major POIs for the city of San Francisco, that includes, Oracle Park, Chase Center, SFMOMA, San Francisco City Hall, Salesforce Tower, Ferry Building, Pier 39, Fisherman's Wharf, The Transamerica Pyramid, Union Square, Coit Tower, Bay Bridge, Fort Mason Center, Golden Gate Bridge, Fort Point, Sutro Tower, Twin Peaks, Palace of Fine Arts, De Young Museum, California Academy of Science, Alcatraz Island, and Treasure Island.

In an example, the system may return a photo or a thumbnail in response to a search to the user to allow the user to determine whether the POI of interest is displayed when there is more than one major POI in the designated search area. This may also be beneficial for searches that include general POIs.

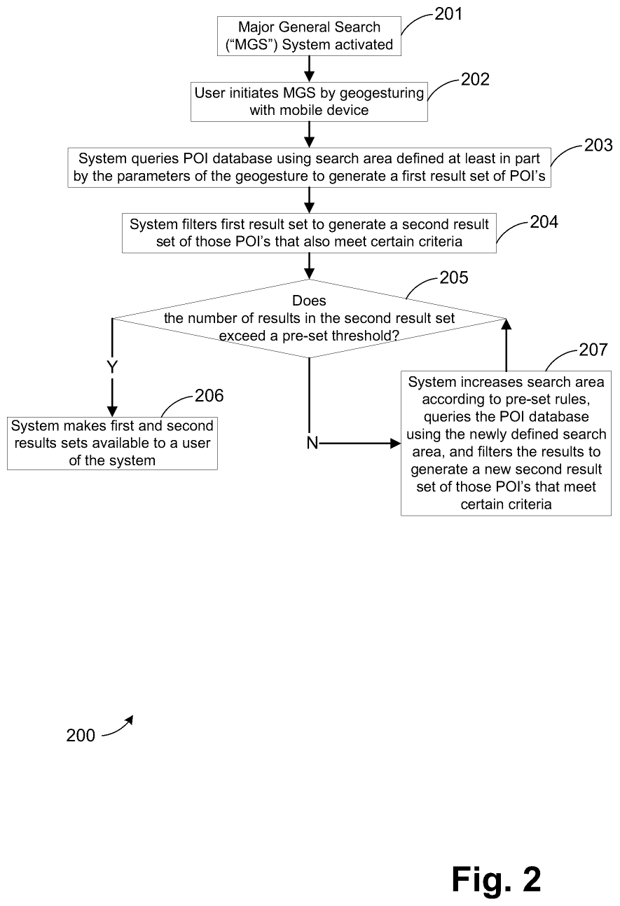

FIG. 2 is a flowchart 200 illustrating a possible mode of operation of the system for searching and displaying a geographic point of interest based on a first database of POI and a second database of POI. In step 201, the user-initiates the POI search system on a spatially aware mobile device. In step 202, the system obtains a first position and orientation of a mobile device based on an initial position of the mobile device or first state of the mobile device and a second position and orientation of the mobile device at the end of the movement of the mobile device. The system saves a first ray defined by the obtained first position and orientation of the mobile device The system saves a second ray defined by obtained second position and orientation of the mobile device. The system determines a geogesture based on the first and second ray. The system may detect the motion between the two positions is shown as an arrow, such as a motion is in the vertical plane or horizontal plane. In step 203, the system obtains a first set of results based on the determined gesture. For example, the system may query a first geocoded point of interest (“POI”) database by ascertaining which POI's location or extent are at least partially encompassed or intersected by a search area that is at least in part defined by the determined gesture to produce a first result set of POI's. In step 204, the system filters the first search result to generate a second search result that meets a certain criteria. For example, the system may determine a second search result that includes large buildings in the vicinity of the mobile device. In step 205, the system determines whether the number of results in the first result set exceeds a pre-determined set threshold. If the number of results in the second result set does not exceeds a predetermined set threshold, the flowchart branches to 206. If the number of results in the second result set does exceeds a predetermined set threshold, the flowchart branches to 207.

In step 207, the system determines a second filtering criteria that increases the first set of search results. For example, the system increases the search area according to pre-set rules (e.g., increase the range threshold by 50% and the angular extent by 20%) and queries the second POI database using the newly defined search area to generate a new second result set of POI's. The flowchart then branches back to step 205.

In step 206, the system makes the first set of search results and the second set of search results available to a user of the system. For example, the system may make available the search results with the major search results that are filtered and the general search results that are not filtered available on the same screen so that the user does not miss out on either the major search results or the general search results.

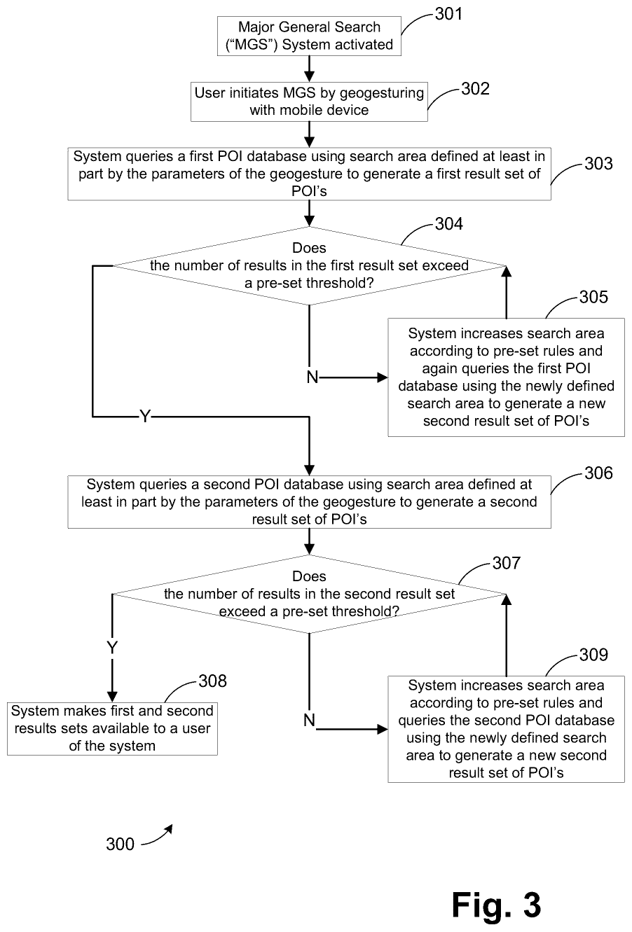

FIG. 3 is a flowchart 300 illustrating a possible mode of operation of the invention utilizing a geogesture. In step 301 the system is activated on a spatially aware mobile device. The flowchart then branches to step 302. In step 302 a user of the system initiates an MGS search by geogesturing with the mobile device. The flowchart then branches to step 303. In step 303 the system queries a first geocoded point of interest (“POI”) database by ascertaining which POI's location or extent are at least partially encompassed or intersected by a search area that is at least in part defined by the geogesture of the mobile device to produce a first result set of POI's. The flowchart then branches to step 304 in which the system determines if the number of POIs in the first result set exceeds a pre-set threshold. If the number of POIs in the first result set does exceed the pre-set threshold, then the flowchart branches to step 306. If the number of POIs in the first result does not exceed the pre-set threshold the flowchart branches to step 305. In step 305 the system increases the search area according to pre-set rules (e.g., increase the range threshold by 50%) and queries the first POI database using the newly defined search area to generate a new second result set of POI's. The flowchart then branches back to strep 304. In step 306 the system queries a second geocoded point of interest (“POI”) database by ascertaining which POI's location or extent are at least partially encompassed or intersected by a search area that is at least in part defined by the geogesture of the mobile device to produce a second result set of POI's. The flowchart then branches to step 307 in which the system determines if the number of POIs in the second result set exceeds a pre-set threshold. If the number of POIs in the second result set does exceed the pre-set threshold, then the flowchart branches to step 308 in which the system makes the first and second result sets available to the user and/or application for interaction, etc. If the number of POIs in the second result does not exceed the pre-set threshold the flowchart branches to step 309. In step 309 the system increases the search area according to pre-set rules (e.g., increase the range threshold by 50% and the angular extent by 20%) and queries the second POI database using the newly defined search area to generate a new second result set of POI's. The flowchart then branches back to strep 307. By using such a method as described above a user may simultaneously search a database of “General” POI's (the first POI database) to obtain a first result set, and a database of “Major” POI's (the second POI database) to obtain a second result set simultaneously. In an embodiment, the system determines a second set of search results based on a second filtering criteria. In an example, the filtering criteria may be based on the attributes that are associated with a POI in the pointing direction of the mobile device. Examples of the attributes include the physical size of the POI, the social media attributes associated with the POI, the age of the POI, and the historical significance of the POI. The POIs within the gesture bounded by the first ray and the second ray may be classified into Major or General POI based on one or more attributes.

It should be noted that, again, the iterations of increasing the search area if the minimum threshold for results for each search is not met may itself be limited. It should also be noted that the initial search areas used to do the initial search in the first and second POI databases may be identical or may be different and discrete.

By using such a method as described above a user may simultaneously search a database of “General” POI's (the first POI database) to obtain a first result set, and a database of “Major” POI's (the second POI database) to obtain a second result set simultaneously. It should be noted that, again, the iterations of increasing the search area if the minimum threshold for results for each search is not met may itself be limited. It should also be noted that the initial search areas used to do the initial search in the first and second POI databases may be identical or may be different and discrete.

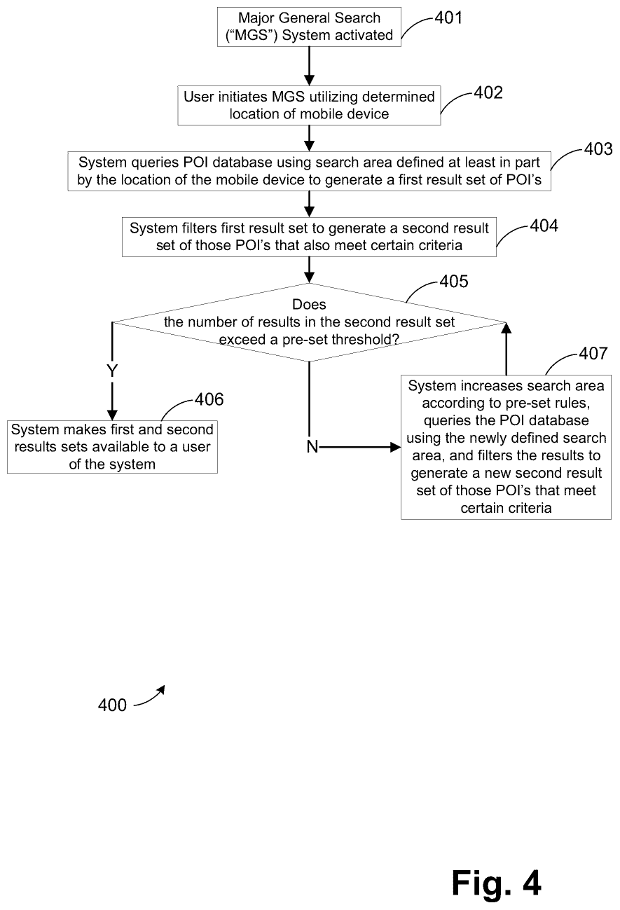

FIG. 4 is a flowchart 400 illustrating a possible mode of operation of embodiments utilizing a device determined position. In step 401, the user-initiates the POI location generation system such as on a spatially aware mobile device. The system obtains a first position and orientation of a mobile device based on an initial position of the mobile device. The system obtains a second position and orientation of the mobile device at the end of the movement of the mobile device. The system saves a first ray defined by the obtained first position and orientation of the mobile device. The system saves second ray defined by obtained second position and orientation of the mobile device. The system determines a gesture based on the first and second ray. The system may detect the motion between the two positions is shown as an arrow, such as a motion is in the vertical plane or horizontal plane. In step 402, the system determines a location of the device based on the determined gesture. In step 403, the system obtains a first set of results based on the determined location of the mobile device. The system queries a geocoded point of interest (“POI”) database by ascertaining which POI's location or extent are at least partially encompassed or intersected by a search area that is at least in part defined by the gesture of the mobile device to produce a first set of result corresponding to the of POI's. Such a search area may be, for example, a vector defined by the position and pointing direction of the mobile device and a range threshold, a search sector defined by the position and pointing direction of the mobile device, an angular range related to the pointing direction of the mobile device, and a range threshold, etc. In step 404, the system determines a second set of search results based on a first filtering criterion. In an example, the filtering criteria may be based on the attributes that are associated with a POI in the pointing direction of the mobile device. Examples of the attributes include the physical size of the POI, the social media attributes associated with the POI, the age of the POI, and the historical significance of the POI. The POIs within the gesture bounded by the first ray and the second ray may be classified into Major or General POI based on one or more attributes.

In step 405, the system determines whether the number of results in the second result set exceeds a pre-determined set threshold. If the number of results in the second result set does not exceeds a predetermined set threshold, the flowchart branches to 407. In step 407, the system determines a second filtering criteria that increases the second set of search results. For example, the system increases the search area according to pre-set rules (e.g. increase the range threshold by 50%), queries the POI database using the newly defined search area, and filters the results to generate a new second result set of those POI's that meet certain criteria.

The flowchart then branches back to step 405. If the number of results in the second result set exceeds a predetermined set threshold, the flowchart branches to 406. In step 406, the system displays the first and the second set of results on the mobile device. It should be noted that while as described in this method the system constantly monitors the position of the mobile device to determine a gesture to determine a new point of interest.

By using such a method as described above a user may simultaneously search a database of POIs to obtain a “General” search result, the first result set, and a “Major” search result, the second result set simultaneously. It should also be noted that the initial general search may also have an associated minimum threshold for results that, if not met, would also increase the search area for that search. It should also be noted that the iterations of increasing the search area if the minimum threshold for results is not met may itself be limited, e.g., if after two iterations the results set does not meet the minimum required no more iterations are performed. If a maximum range threshold has been reached for the extent of the search area, then the system might end there and perform no more iterations. It should also be noted that a simpler version of such a search method as described above need not include a minimum result threshold and instead would return the results of the initial search and filtering as is.

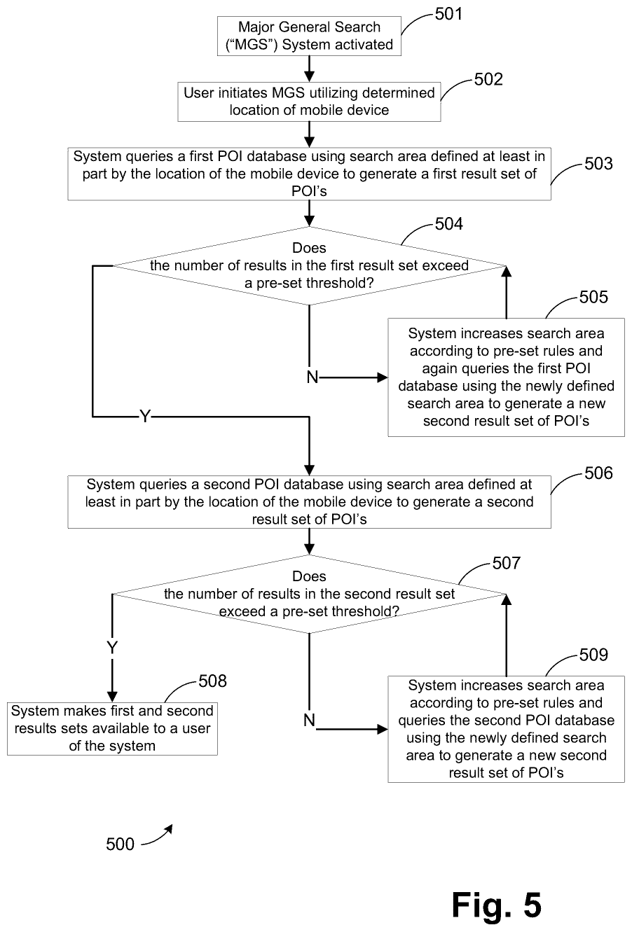

FIG. 5 is a flowchart 500 illustrating a possible mode of operation of embodiments utilizing a search based on a location of the device and a first database and a second database of POI. In step 501, the user-initiates the POI location generation system such as on a spatially aware mobile device. The system obtains a first position and orientation of a mobile device based on an initial position of the mobile device. The system obtains a second position and orientation of the mobile device at the end of the movement of the mobile device. The system saves a first ray defined by the obtained first position and orientation of the mobile device. The system saves second ray defined by obtained second position and orientation of the mobile device. The system determines a gesture based on the first and second ray. The system may detect the motion between the two positions is shown as an arrow, such as a motion is in the vertical plane or horizontal plane. In step 502, the system may determine a location of the device based on the second ray. In step 503, the system obtains a first set of results based on the determined location of the device. For example, the system may query a first geocoded point of interest (“POI”) database by ascertaining which POI's location or extent are at least partially encompassed or intersected by a search area that is at least in part defined by the determined location to produce a first result set of POI's. In step 504, the system determines whether the number of results in the first result set exceeds a pre-determined set threshold. If the number of results in the second result set does not exceeds a predetermined set threshold, the flowchart branches to 505. If the number of results in the second result set does exceeds a predetermined set threshold, the flowchart branches to 506.

In step 505, the system determines a second filtering criteria that increases the first set of search results. For example, the system increases the search area according to pre-set rules (e.g., increase the range threshold by 50% and the angular extent by 20%) and queries the second POI database using the newly defined search area to generate a new second result set of POI's. The flowchart then branches back to step 504.

In step 506, the system determines a second set of search results based on a second filtering criteria. In an example, the filtering criteria may be based on the attributes that are associated with a POI in the pointing direction of the mobile device. Examples of the attributes include the physical size of the POI, the social media attributes associated with the POI, the age of the POI, and the historical significance of the POI. The POIs within the gesture bounded by the first ray and the second ray may be classified into Major or General POI based on one or more attributes.

In step 507, the system determines whether the number of results in the second result set exceeds a second pre-determined set threshold. If the number of results in the second result set does not exceeds a second predetermined set threshold, the flowchart branches to 509.

In step 509, the system determines a third filtering criteria that increases the second set of search results. For example, the system increases the search area according to pre-set rules (e.g., increase the range threshold by 50% and the angular extent by 20%) and queries the second POI database using the newly defined search area to generate a new second result set of POI's. The flowchart then branches back to step 507.

In step 508, the system displays the first and the second set of results on the screen of the mobile device.

By using such a method as described above a user may simultaneously search a database of “General” POI's (the first POI database) to obtain a first result set, and a database of “Major” POI's (the second POI database) to obtain a second result set simultaneously. It should be noted that, again, the iterations of increasing the search area if the minimum threshold for results for each search is not met may itself be limited. It should also be noted that the initial search areas used to do the initial search in the first and second POI databases may be identical or may be different and discrete.

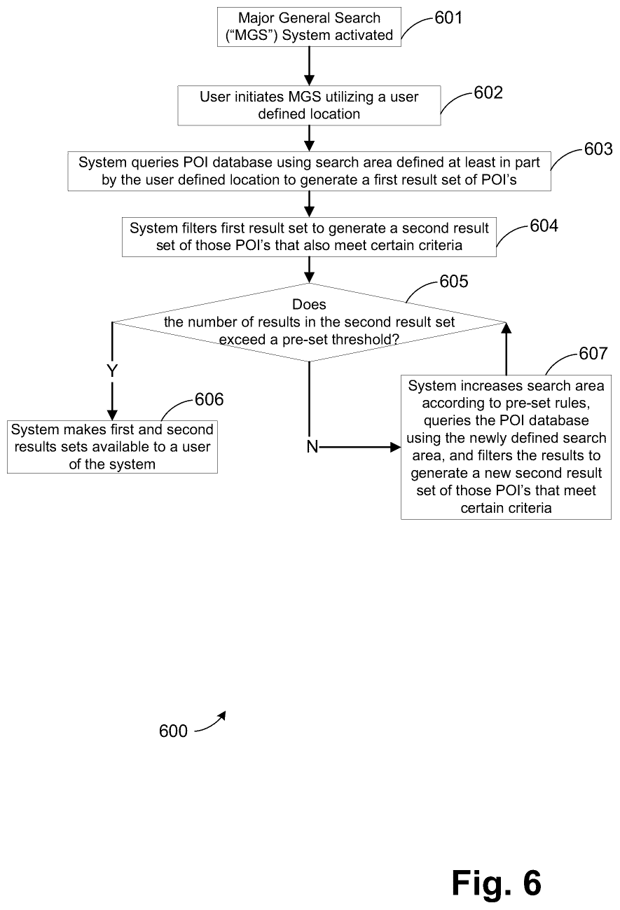

FIG. 6 is a flowchart 600 illustrating a possible mode of operation of embodiments utilizing a search based upon a user selected position. In step 601, the user-initiates the POI location generation system such as on a spatially aware mobile device. In step 602, the system receives a user defined location. In step 603, the system obtains a first set of results based on the user defined location. In an example, the search may be a radius defined search, i.e., a circular search based on the user defined location and a range threshold. The system queries a geocoded point of interest (“POI”) database by ascertaining which POI's location or extent are at least partially encompassed or intersected by a search area that is at least in part defined by the user defined location and range threshold to produce a first set of result corresponding to the of POI's. Such a search area may be, for example, a vector defined by the position and pointing direction of the mobile device selected by the user and a range threshold, a search sector defined by the position and pointing direction of the mobile device, an angular range related to the pointing direction of the mobile device selected by the user, and a range threshold, etc. In step 604, the system determines a second set of search results based on a first filtering criterion. In an example, the filtering criteria may be based on the attributes that are associated with a POI in the pointing direction of the mobile device. Examples of the attributes include the physical size of the POI, the social media attributes associated with the POI, the age of the POI, and the historical significance of the POI. The POIs within the gesture bounded by the first ray and the second ray may be classified into Major or General POI based on one or more attributes.

In step 605, the system determines whether the number of results in the second result set exceeds a pre-determined set threshold. If the number of results in the second result set does not exceeds a predetermined set threshold, the flowchart branches to 607. In step 607, the system determines a second filtering criteria that increases the second set of search results. For example, the system increases the search area according to pre-set rules (e.g. increase the range threshold by 50%), queries the POI database using the newly defined search area, and filters the results to generate a new second result set of those POI's that meet certain criteria.

The flowchart then branches back to step 605. If the number of results in the second result set exceeds a predetermined set threshold, the flowchart branches to 606. In step 606, the system displays the first and the second set of results on the mobile device. It should be noted that while as described in this method the system constantly monitors the position of the mobile device to determine a gesture to determine a new point of interest.

By using such a method as described above the system may simultaneously search a database of POIs to obtain a “General” search result, the first result set, and a “Major” search result, the second result set simultaneously. It should also be noted that the initial general search may also have an associated minimum threshold for results that, if not met, would also increase the search area for that search. It should also be noted that the system may be based on the iterations of increasing the search area determine whether the minimum threshold for results is not met and the system may limit further searches. For example, when the system determines after two iterations the results set does not meet the minimum required the system may not perform iterations or if a maximum range threshold has been reached for the extent of the search area, then the system does not perform further iterations. It should also be noted that a simpler version of such a search method as described above need not include a minimum result threshold and instead would return the results of the initial search and filtering as.

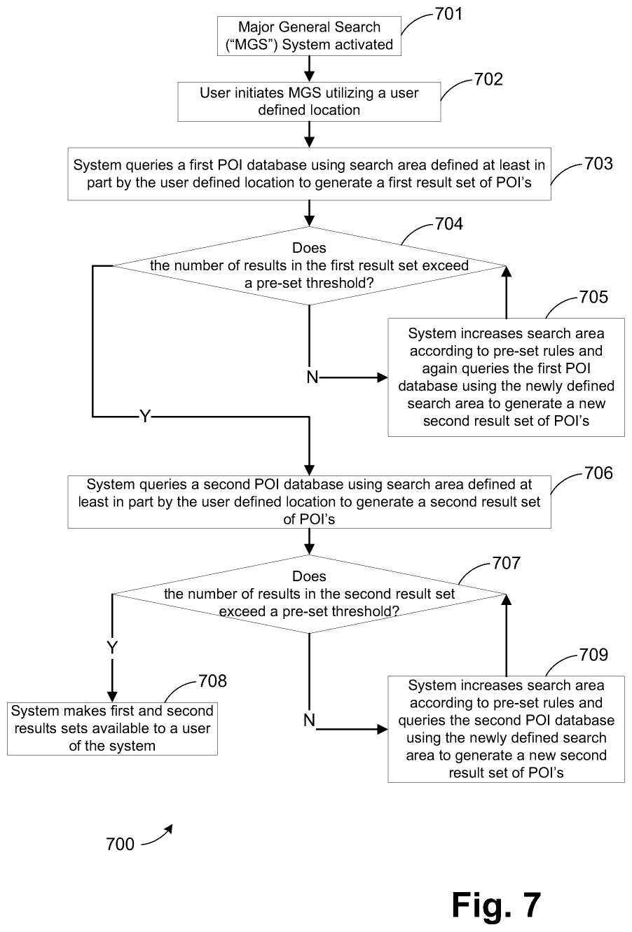

FIG. 7 is a flowchart 700 illustrating a possible mode of operation of the system for searching and displaying a geographic point of interest based on a user defined location. In step 701, the user-initiates the POI location generation system such as on a spatially aware mobile device. In step 702, the system determines a user defined location. In step 703, the system obtains a first set of results based on the user defined location. For example, the system may query a first geocoded point of interest (“POI”) database by ascertaining which POI's location or extent are at least partially encompassed or intersected by a search area that is at least in part defined by the user defined location to produce a first result set of POI's. In step 704, the system determines whether the number of results in the first result set exceeds a pre-determined set threshold. If the number of results in the second result set does not exceeds a predetermined set threshold, the flowchart branches to 705. If the number of results in the second result set does exceeds a predetermined set threshold, the flowchart branches to 706.

In step 706, the system determines a second filtering criteria that increases the first set of search results. For example, the system increases the search area according to pre-set rules (e.g., increase the range threshold by 50% and the angular extent by 20%) and queries the second POI database using the newly defined search area to generate a new second result set of POI's. The flowchart then branches back to step 707.

In step 706, the system determines a second set of search results based on a second filtering criteria. In an example, the filtering criteria may be based on the attributes that are associated with a POI in the pointing direction of the mobile device. Examples of the attributes include the physical size of the POI, the social media attributes associated with the POI, the age of the POI, and the historical significance of the POI. The POIs within the gesture bounded by the first ray and the second ray may be classified into Major or General POI based on one or more attributes.

In step 707, the system determines whether the number of results in the second result set exceeds a second pre-determined set threshold. If the number of results in the second result set does not exceeds a second predetermined set threshold, the flowchart branches to 709.

In step 709, the system determines a third filtering criteria that increases the second set of search results. For example, the system increases the search area according to pre-set rules (e.g., increase the range threshold by 50% and the angular extent by 20%) and queries the second POI database using the newly defined search area to generate a new second result set of POI's. The flowchart then branches back to step 707.

In step 708, the system displays the first and the second set of results on the screen of the mobile device.

By using such a method as described above a user may simultaneously search a database of “General” POI's (the first POI database) to obtain a first result set, and a database of “Major” POI's (the second POI database) to obtain a second result set simultaneously. It should be noted that, again, the iterations of increasing the search area if the minimum threshold for results for each search is not met may itself be limited. It should also be noted that the initial search areas used to do the initial search in the first and second POI databases may be identical or may be different and discrete.

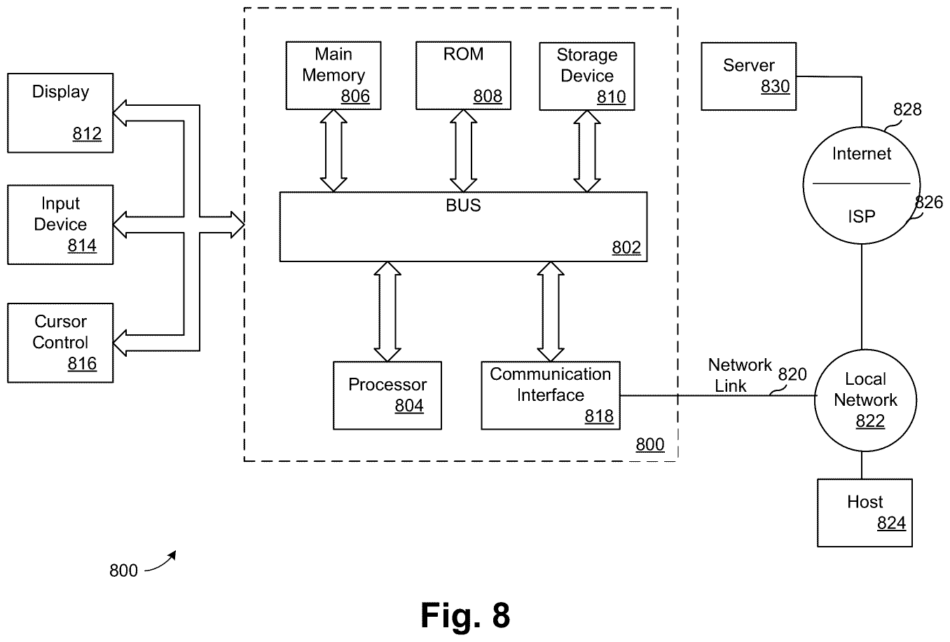

For example, FIG. 8 is a block diagram that illustrates a computer system 800 upon which the computer systems of the systems described herein may be implemented. Computer system 800 includes a bus 802 or other communication mechanism for communicating information, and a processor 804 coupled with bus 802 for processing information. Processor 804 may be, for example, a general-purpose microprocessor.

Computer system 800 also includes a main memory 806, such as a random-access memory (RAM) or other dynamic storage device, coupled to bus 802 for storing information and instructions to be executed by processor 804. Main memory 806 may also be used for storing temporary variables or other intermediate information during execution of instructions to be executed by processor 804. Such instructions, when stored in non-transitory storage media accessible to processor 804, render computer system 800 into a special-purpose machine that is customized to perform the operations specified in the instructions.

Computer system 800 further includes a read only memory (ROM) 808 or other static storage device coupled to bus 802 for storing static information and instructions for processor 804. A storage device 810, such as a magnetic disk or optical disk, is provided and coupled to bus 802 for storing information and instructions.

Computer system 800 may be coupled via bus 802 to a display 812, such as a computer monitor, for displaying information to a computer user. An input device 814, including alphanumeric and other keys, is coupled to bus 802 for communicating information and command selections to processor 804. Another type of user input device is a cursor control 816, such as a mouse, a trackball, or cursor direction keys for communicating direction information and command selections to processor 804 and for controlling cursor movement on display 812. This input device typically has two degrees of freedom in two axes, a first axis (e.g., x) and a second axis (e.g., y), that allows the device to specify positions in a plane.

Computer system 800 may implement the techniques described herein using customized hard-wired logic, one or more ASICs or FPGAs, firmware and/or program logic which in combination with the computer system causes or programs computer system 800 to be a special-purpose machine. According to one embodiment, the techniques herein are performed by computer system 800 in response to processor 804 executing one or more sequences of one or more instructions contained in main memory 806. Such instructions may be read into main memory 806 from another storage medium, such as storage device 810. Execution of the sequences of instructions contained in main memory 806 causes processor 804 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may include non-volatile media and/or volatile media. Non-volatile media includes, for example, optical or magnetic disks, such as storage device 810. Volatile media includes dynamic memory, such as main memory 806. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, an EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire, and fiber optics, including the wires that include bus 802. Transmission media can also take the form of acoustic or light waves, such as those generated during radio-wave and infra-red data communications.

Various forms of media may be involved in carrying one or more sequences of one or more instructions to processor 804 for execution. For example, the instructions may initially be carried on a magnetic disk or solid-state drive of a remote computer. The remote computer can load the instructions into its dynamic memory and send the instructions over a network connection. A modem or network interface local to computer system 800 can receive the data. Bus 802 carries the data to main memory 806, from which processor 804 retrieves and executes the instructions. The instructions received by main memory 806 may optionally be stored on storage device 810 either before or after execution by processor 804.

Computer system 800 also includes a communication interface 818 coupled to bus 802. Communication interface 818 provides a two-way data communication coupling to a network link 820 that is connected to a local network 822. For example, communication interface 818 may be a network card, a modem, a cable modem, or a satellite modem to provide a data communication connection to a corresponding type of telephone line or communications line. Wireless links may also be implemented. In any such implementation, communication interface 818 sends and receives electrical, electromagnetic, or optical signals that carry digital data streams representing various types of information.

Network link 820 typically provides data communication through one or more networks to other data devices. For example, network link 820 may provide a connection through local network 822 to a host computer 824 or to data equipment operated by an Internet Service Provider (ISP) 826. ISP 826 in turn provides data communication services through the world-wide packet data communication network now commonly referred to as the “Internet” 828. Local network 822 and Internet 828 both use electrical, electromagnetic, or optical signals that carry digital data streams. The signals through the various networks and the signals on network link 820 and through communication interface 818, which carry the digital data to and from computer system 800, are example forms of transmission media.

Computer system 800 can send messages and receive data, including program code, through the network(s), network link 820, and communication interface 818. In the Internet example, a server 830 might transmit a requested code for an application program through the Internet 828, ISP 826, local network 822, and communication interface 818. The received code may be executed by processor 804 as it is received, and/or stored in storage device 810, or other non-volatile storage for later execution.

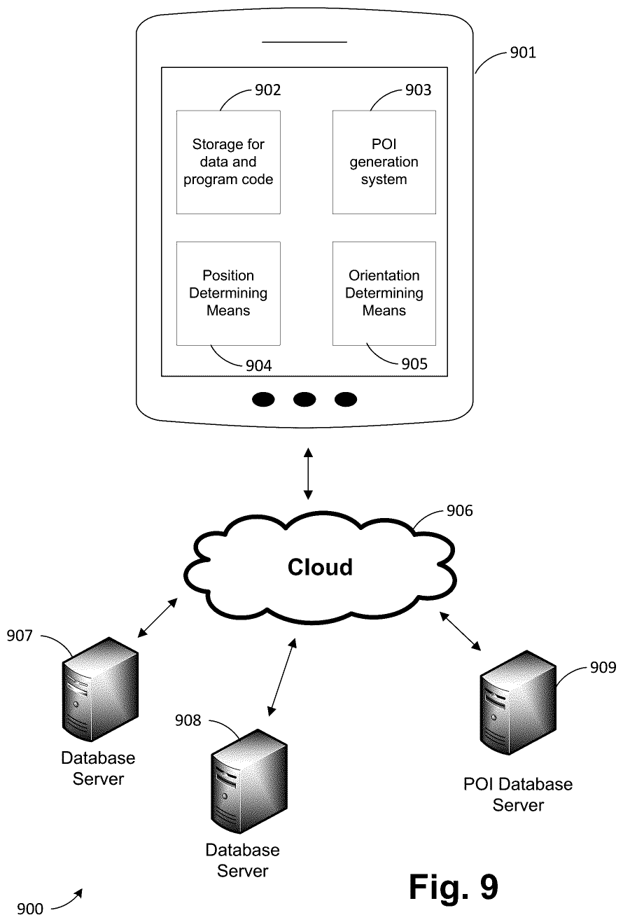

FIG. 9 is a simplified functional block diagram 900 of an embodiment of a networked smart phone operable for generating POIs. A Smart Phone 901 comprises, among other components, storage for data and program code 902, a POI gesture search subsystem, a position determining means 904 and an orientation determining means 905. Data from the position determining means 904 and orientation determining means 905 is utilized by the POI generation subsystem to generate a gesture. The determined gestured is used to search the POI database using various methods as described above. The smart phone is in communication via the cloud 906 with various database servers 907 and 908 that may contain additional information relating to the new POI. This additional information may be accessed by the POI generation subsystem 903 and appended to the information defining the new POI. The information defining the new POI is then transmitted via the cloud 906 to a POI database server 909 in which the information defining the new POI is stored and made available to various applications.

Moving POIs may only update their geolocation if their position changed beyond a pre-defined threshold of distance and the velocity as determined by the GPS device is less than a pre-defined threshold. This thereby eliminates the continuous updating of geolocation that can cause server overload and bandwidth at scale. The pre-defined threshold might be a value set by the user or a developer of the program.

According to one embodiment, the techniques described herein are implemented by one or more generalized computing systems programmed to perform the techniques pursuant to program instructions in firmware, memory, other storage, or a combination. Special-purpose computing devices may be used, such as desktop computer systems, portable computer systems, handheld devices, networking devices or any other device that incorporates hard-wired and/or program logic to implement the techniques.

Operations of processes described herein can be performed in any suitable order unless otherwise indicated herein or otherwise clearly contradicted by context. Processes described herein (or variations and/or combinations thereof) may be performed under the control of one or more computer systems configured with executable instructions and may be implemented as code (e.g., executable instructions, one or more computer programs or one or more applications) executing collectively on one or more processors, by hardware or combinations thereof. The code may be stored on a computer-readable storage medium, for example, in the form of a computer program comprising a plurality of instructions executable by one or more processors. The computer-readable storage medium may be non-transitory. The code may also be provided carried by a transitory computer readable medium e.g., a transmission medium such as in the form of a signal transmitted over a network.

Conjunctive language, such as phrases of the form “at least one of A, B, and C,” or “at least one of A, B and C,” unless specifically stated otherwise or otherwise clearly contradicted by context, is otherwise understood with the context as used in general to present that an item, term, etc., may be either A or B or C, or any nonempty subset of the set of A and B and C. For instance, in the illustrative example of a set having three members, the conjunctive phrases “at least one of A, B, and C” and “at least one of A, B and C” refer to any of the following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present.

The use of examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

Further embodiments can be envisioned to one of ordinary skill in the art after reading this disclosure. In other embodiments, combinations or sub-combinations of the above-disclosed invention can be advantageously made. The example arrangements of components are shown for purposes of illustration and combinations, additions, re-arrangements, and the like are contemplated in alternative embodiments of the present invention. Thus, while the invention has been described with respect to exemplary embodiments, one skilled in the art will recognize that numerous modifications are possible.

For example, the processes described herein may be implemented using hardware components, software components, and/or any combination thereof. The specification and drawings are, accordingly, to be regarded in an illustrative rather than a restrictive sense. It will, however, be evident that various modifications and changes may be made thereunto without departing from the broader spirit and scope of the invention as set forth in the claims and that the invention is intended to cover all modifications and equivalents within the scope of the following claims.

All references, including publications, patent applications, and patents, cited herein are hereby incorporated by reference to the same extent as if each reference were individually and specifically indicated to be incorporated by reference and were set forth in its entirety herein.

What is claimed is:

1. A method of retrieving a point of interest data accessible over a network by location-aware devices, the method comprising:
determining a first state of a mobile device and a second state of the mobile device;
determining a gesture based on the first state and the second state of the mobile device;
obtaining a first set of search results, via a first query of a first point of interest (POI) database, based at least in part on the determined gesture;
determining a second set of search results based on a first filtering criterion; and
displaying the first and second set of search results on the mobile device.

2. The method of claim 1, wherein the method further comprising:
determining whether a number of results in the second set of search results does not exceed a pre-defined threshold;
based on a determination the number of results in the second set of search results does not exceed the pre-defined threshold, determining a second filtering criteria, the second filtering criteria selected based on a pre-defined filtering criteria that increase the second set of search results;
determining an updated second set of search results based on the second filtering criteria; and
displaying the first set of search results and the updated second set of search results on the mobile device.

3. The method of claim 1, wherein the method further comprising:
determining a second gesture at the mobile device;
determining based on the second gesture a combination of the first and second set of search results; and
displaying the combination of the first set of search results and the second set of search results on the mobile device.

4. The method of claim 1, wherein the first set of search results is based on the first query of the first POI database and wherein based on the first filtering criterion the second set of search results are determined based on a second query of a second POI database.

5. The method of claim 1, wherein the first set of search results is based on a first parameter of an object located at the POI.

6. The method of claim 1, wherein the second set of search results is based on the POI located near a location of the mobile device.

7. A computer system comprising:
at least one processor; and
a computer-readable medium storing instructions, which when executed by the at least one processor, causes the computer system to:
determine a first state of a mobile device and a second state of the mobile device;
determine a gesture based on the first state and the second state of the mobile device;
obtain a first set of search results, via a first query of a first point of interest (POI) database, based at least in part on the determined gesture;
obtain a second set of search results, via a second query of a second point of interest (POI) database, based at least in part on the determined gesture; and
display the first and second set of search results on the mobile device.

8. The system of claim 7, when the instructions executed by the at least one processor, causes the computer system to:
determine a second gesture at the mobile device;
determine based on the second gesture a combination of the first and second set of search results; and
display the combination of the first set of search results and the second set of search results on the mobile device.

9. The system of claim 7, wherein the first set of search results is based on a first parameter of an object located at the POI.

10. The system of claim 7, when the first filtering criterion is based on physical size of an object.
